(19) United States
(12) Patent Application Publication
(10) Pub. No.: US 2025/0237916 A1
(43) Pub. Date: Jul. 24, 2025

(54) DISPLAY DEVICE

(71) Applicant: Innolux Corporation, Miaoli County (TW)

(72) Inventors: Wei-Yen Chiu, Miaoli County (TW); Yi-Hsiu Wu, Miaoli County (TW); Chih-Hao Chang, Miaoli County (TW); Chia-Hao Tsai, Miaoli County (TW)

(73) Assignee: Innolux Corporation, Miaoli County (TW)

(21) Appl. No.: 18/991,677

(22) Filed: Dec. 22, 2024

(30) Foreign Application Priority Data
Jan. 24, 2024 (CN) 202410100541.5

(51) Int. Cl. G02F 1/1362; G02F 1/1368

(52) U.S. Cl. CPC G02F 1/136286; G02F 1/136209; G02F 1/1368

(57) ABSTRACT

A display device including a thin-film transistor (TFT) substrate, a counter substrate, a display medium, a data line pattern, a light-shielding layer and a color resist layer. The counter substrate is opposite to the TFT substrate. The display medium is sandwiched between the TFT substrate and the counter substrate. The data line pattern is disposed on the TFT substrate. The light-shielding layer is disposed on the data line pattern and includes a first metal layer and a second metal layer. The color resist layer is disposed between the data line pattern and the light-shielding layer. The second metal layer is disposed on the first metal layer, and a thickness of the second metal layer is greater than a thickness of the first metal layer.

### CROSS-REFERENCE TO RELATED APPLICATION

This application claims the priority benefit of China application serial no. 202410100541.5, filed on Jan. 24, 2024. The entirety of the above-mentioned patent application is hereby incorporated by reference herein and made a part of this specification.

### BACKGROUND

### Technical Field

The disclosure relates to a display device.

### Description of Related Art

In a display device having a high pixel density, a customer could be aware of a mixed color image easily when viewing the display device at an oblique viewing angle, resulting in the poor display quality perceived by the customer.

### SUMMARY

The disclosure provides a display device having a relatively good display quality.

According to some embodiments of the disclosure, the display device including a thin-film transistor substrate, a counter substrate, a display medium, a data line pattern, a light-shielding layer, and a light-shielding layer is provided. The counter substrate is correspondingly disposed on the thin-film transistor substrate. The display medium is sandwiched between the thin-film transistor substrate and the counter substrate. The data line pattern is disposed on the thin-film transistor substrate. The light-shielding layer is disposed on the data line pattern and includes a first metal layer and a second metal layer. The color resist layer is disposed between the data line pattern and the light-shielding layer. The second metal layer is disposed on the first metal layer, and a thickness of the second metal layer is greater than a thickness of the first metal layer.

According to another embodiments of the disclosure, the display device including a thin-film transistor substrate, a counter substrate, a display medium, a data line pattern, a light-shielding layer, and a light-shielding layer is provided. The counter substrate is correspondingly disposed on the thin-film transistor substrate. The display medium is sandwiched between the thin-film transistor substrate and the counter substrate. The data line pattern is disposed on the thin-film transistor substrate. The light-shielding layer is disposed on the data line pattern and includes a first metal layer and a second metal layer. The color resist layer is disposed on the light-shielding layer, wherein the light-shielding layer is disposed between the data line pattern and the color resist layer. The second metal layer is disposed on the first metal layer, and a thickness of the second metal layer is greater than a thickness of the first metal layer.

Based on the above, the light-shielding layer in the display device provided by the present disclosure includes the first metal layer and the second metal layer, and the light-shielding layer and the color resist layer in the display device provided by the present disclosure are integrated on the same thin-film transistor substrate, so that the light-shielding layer could have the characteristics of low transmittance and/or low reflectance, and could reduce the phenomenon of mixed color image when viewing the display device at the oblique viewing angle, thereby improving the contrast ratio of the display device provided by the present disclosure when viewing at a wide viewing angle.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic cross-sectional view of a display device according to a first embodiment of the present disclosure.

FIG. 2 is a schematic cross-sectional view of a display device according to a second embodiment of the present disclosure.

FIG. 3 is a schematic cross-sectional view of a display device according to a third embodiment of the present disclosure.

FIG. 4 is a schematic cross-sectional view of a display device according to a fourth embodiment of the present disclosure.

FIG. 5 is a partial cross-sectional view of a region provided with a light-shielding layer in the display device according to the first embodiment of the present disclosure.

FIG. 6 is a partial cross-sectional view of a region provided with a light-shielding layer in the display device according to the second embodiment of the present disclosure.

FIG. 7 is a partial cross-sectional view of a region provided with a light-shielding layer in the display device according to the third embodiment of the present disclosure.

FIG. 8 is a partial cross-sectional view of a region provided with a light-shielding layer in a display device according to the fourth embodiment of the present disclosure.

FIG. 9 is a partial cross-sectional view of a region provided with a light-shielding layer in the display device according to a fifth embodiment of the present disclosure.

FIG. 10 is a partial cross-sectional view of a region provided with a light-shielding layer in the display device according to a sixth embodiment of the present disclosure.

FIG. 11 is a partial cross-sectional view of a region provided with a light-shielding layer in a display device according to a seventh embodiment of the present disclosure.

FIG. 12 is a partial cross-sectional view of a region provided with a light-shielding layer in the display device according to an eighth embodiment of the present disclosure.

FIG. 13 is a partial cross-sectional view of a region provided with a light-shielding layer in the display device according to a ninth embodiment of the present disclosure.

FIG. 14 is a partial cross-sectional view of a region provided with a light-shielding layer in the display device according to a tenth embodiment of the present disclosure.

FIG. 15 is a partial cross-sectional view of a region provided with a light-shielding layer in the display device according to an eleventh embodiment of the present disclosure.

FIG. 16 is a partial cross-sectional view of a region provided with a light-shielding layer in the display device according to a twelfth embodiment of the present disclosure.

### DESCRIPTION OF THE EMBODIMENTS

Reference will now be made in detail to the exemplary embodiments of the disclosure, examples of which are illustrated in the accompanying drawings. Whenever possible, the same reference numbers are used in the drawings and descriptions to refer to the same or similar parts.

The disclosure can be understood by referring to the following detailed description in combination with the accompanying drawings. It should be noted that in order to make it easy for the reader to understand and for the simplicity of the drawings, the multiple drawings in this disclosure only depict a part of the electronic device, and the specific components in the drawings are not drawn according to actual scale. In addition, the number and size of each component in the drawings are only for exemplary purpose, and are not intended to limit the scope of the disclosure.

Throughout the disclosure and the appended claims, certain words are used to refer to specific components. Those skilled in the art should understand that electronic device manufacturers may refer to the same components by different names. The disclosure does not intend to distinguish those components with the same function but different names. In the following description and claims, the terms “including”, “containing”, and “having” are open-ended terms, so they should be interpreted as “include but not limited to . . . ”. Therefore, when the terms “including”, “containing”, and/or “having” are used in the description of this disclosure, they specify the existence of a corresponding feature, region, step, operation, and/or component, but do not exclude the existence of one or more corresponding features, regions, steps, operations, and/or components.

Direction terms mentioned in this specification, such as such as “up,” “down,” “front,” “back,” “left,” and “right,” merely refer to directions in the accompanying drawings. Therefore, the direction terms used is for illustration, not for limiting this disclosure. In the drawings, each drawing shows the general features of the method, structure, and/or material used in a specific embodiment. However, these drawings should not be construed as defining or limiting the scope or nature of the embodiments. For example, for the sake of clarity, the relative size, thickness, and position of each layer, region, and/or structure may be reduced or enlarged.

When a corresponding member (such as a layer or a region) is described as being “on another member,” it may be directly on another member, or there may be other member therebetween. On the other hand, when a member is described as being “directly on another member,” no member exists therebetween. In addition, when a member is described as being “on another member,” the two have a vertical relationship in the top view direction, and this member may be located above or below the other member, and the vertical relationship depends on the device orientation.

The terms “approximately”, “essentially”, or “substantially” are generally interpreted as within 10% of a given value or range, or as within 5%, 3%, 2%, 1%, or 0.5% of the value or range.

Ordinal numbers in this specification and the claims such as “first” and “second” are used to modify a component, and do not imply or represent that the (or these) component(s) has (or have) any ordinal number, and do not indicate any order between a component and another component, or an order in a manufacturing method. These ordinal numbers are merely used to clearly distinguish a component having a name with another component having the same name. Different terms may be used in the claims and the specification, so that a first member in the specification may be a second member in the claims.

It should be understood that the following embodiments may replace, reorganize, and mix the features in several different embodiments to complete other embodiments without departing from the spirit of the disclosure. As long as the features of the embodiments do not violate the spirit of the disclosure or conflict each other, they may be mixed and matched as desired.

Electrical connection or coupling described in the disclosure may refer to direct connection or indirect connection. In the case of direct connection, end points of the components on two circuits are directly connected or connected to each other with a conductor segment, and in the case of indirect connection, there are transistors, diodes, capacitors, inductors, other suitable components, or a combination of the above components between the end points of the components on the two circuits, but the disclosure is not limited thereto.

In the disclosure, a thickness, a length, and a width may be measured using an optical microscope, and the thickness may be measured using a cross-sectional image in an electronic microscope. However, the disclosure is not limited thereto. In addition, any two values or directions used for comparison may have certain errors. If a first direction is perpendicular to a second direction, an angle between the first direction and the second direction may be between 80 degrees and 100 degrees. If the first direction is parallel to the second direction, the angle between the first direction and the second direction may be between 0 degrees and 10 degrees.

The display device in the disclosure could be a non-self-luminous display device or a self-luminous display device, and could be a double-sided display device. The display device could include liquid crystal, light emitting diode (LED), quantum dot (QD), fluorescence, phosphorescence, other suitable display media or a combination thereof. The light emitting diode could include organic light emitting diode (OLED), micro light emitting diode (micro-LED), sub-millimeter light emitting diode (mini-LED) or quantum dots light emitting diode (QDLED), but the disclosure is not limited thereto. It should be noted that the display device could be any of the above-mentioned arrangements and combinations, but the disclosure is not limited thereto. In addition, the shape of the display device could be a rectangular shape, a circular shape, a polygonal shape, a shape with curved edges, or other suitable shapes. The display device could have peripheral systems such as a drive system, a control system, and a light source system.

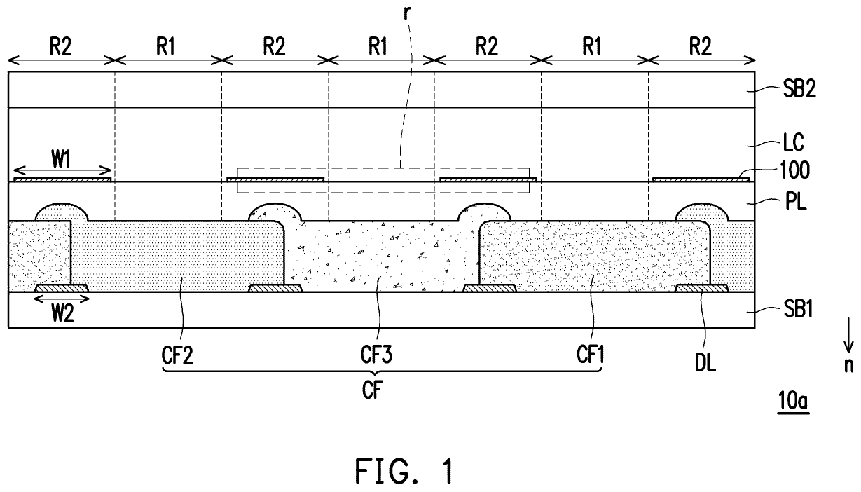

FIG. 1 is a schematic cross-sectional view of a display device according to a first embodiment of the present disclosure.

Referring to FIG. 1, a display device 10a of the present embodiment includes a thin-film transistor substrate SB1, a counter substrate SB2, a display medium LC, a data line pattern DL, a light-shielding layer 100 and a color resist layer CF, but the disclosure is not limited thereto. In some embodiments, the display device 10a could be applied to the electronic devices having high pixel density, such as the virtual reality displays.

The thin-film transistor substrate SB1 could include a first substrate (not shown) and an active component (not shown), but the disclosure is not limited thereto. In some embodiments, the first substrate includes a flexible substrate or an inflexible substrate, wherein a material of the first substrate could include glass, plastic, or a combination thereof. For example, the first substrate could include quartz, sapphire, polymethyl methacrylate (PMMA), polycarbonate (PC), polyimide (PI), polyethylene terephthalate (PET), other suitable materials or a combination thereof. In the present embodiment, the material of the first substrate includes glass, but the disclosure is not limited thereto. The active component is disposed on the first substrate. In some embodiments, the active component includes a gate (not shown), a source (not shown), a drain (not shown), and a semiconductor layer (not shown), but the disclosure is not limited thereto. The gate could at least partially overlap the semiconductor layer, wherein a region where the semiconductor layer overlaps the gate could be regarded as a channel region of the active component. The source and the drain are separated from each other, and are electrically connected to the semiconductor layer. In some embodiments, a material of the semiconductor layer could include amorphous silicon, low-temperature polysilicon (LTPS), a metal oxide, other suitable materials, or a combination thereof, wherein the metal oxide could include indium gallium zinc oxide (IGZO), but the disclosure is not limited thereto.

The counter substrate SB2 is correspondingly disposed on the thin-film transistor substrate SB1. A material of the counter substrate SB2 could be the same as or similar to the material of the first substrate of the thin-film transistor substrate SB1, which would be omitted herein.

The display medium LC is sandwiched between the thin-film transistor substrate SB1 and the counter substrate SB2. In the present embodiment, a material of the display medium LC could include liquid crystal molecules. For example, the display medium LC could include electrically controlled birefringence (ECB) liquid crystal molecules, vertical alignment (VA) liquid crystal molecules, or other suitable liquid crystal molecules, but the disclosure is not limited thereto. The display medium LC could be formed between the thin-film transistor substrate SB1 and the counter substrate SB2 by performing a one drop fill (ODF) process, but the disclosure is not limited thereto.

The data line pattern DL is disposed on the thin-film transistor substrate SB1. In some embodiments, the data line pattern DL could extend along a direction perpendicular to a top-view direction n of the display device 10a, but the disclosure is not limited thereto. The source of the active component in the thin-film transistor substrate SB1 is electrically connected to the corresponding data line pattern DL to receive the corresponding data signal. In some embodiments, a material of the data line pattern DL includes molybdenum (Mo), titanium (Ti), tantalum (Ta), niobium (Nb), hafnium (Hf), nickel (Ni), chromium (Cr), cobalt (Co), zirconium (Zr), tungsten (W), aluminum (Al), copper (Cu), silver (Ag), other suitable metals, alloys or a combination thereof, but the disclosure is not limited thereto.

The light-shielding layer 100 is disposed on the data line pattern DL. In the present embodiment, the light-shielding layer 100 is disposed on the thin-film transistor substrate SB1 and is located between the thin-film transistor substrate SB1 and the display medium LC. In the present embodiment, in the cross-sectional view of the display device 10a, a width W1 of the light-shielding layer 100 is greater than a width W2 of the data line pattern DL. The light-shielding layer 100 could include the material with lower transmittance and/or lower reflectance, thereby the light-shielding layer 100 could be used to shield components and traces (such as the data line pattern DL and/or the active components in the thin-film transistor substrate SB1) located inside the display device 10a that are not intended to be seen by the customer. Namely, the light-shielding layer 100 could be used to define an opening area R1 and a non-opening area R2 of the display device 10a. In the present embodiment, a material of the light-shielding layer 100 could include a conductive material including metal and metal oxide, and/or insulating material (such as oxide and nitride). The specific material of the light-shielding layer 100 would be described in detail in the following embodiments. In some embodiments, if the material of the light-shielding layer 100 includes the conductive material, the light-shielding layer 100 and a common electrode (not shown) could have the same potential, but the disclosure is not limited thereto. In the present embodiment, the light-shielding layer 100 includes a multi-layer structure, which would be described in detail in the following embodiments.

The color resist layer CF is disposed between the data line pattern DL and the light-shielding layer 100. In the present embodiment, the color resist layer CF is disposed on the thin-film transistor substrate SB1 and is located between the thin-film transistor substrate SB1 and the display medium LC. Based on the above, the display device 10a shown in the present embodiment includes a lower substrate on which the color resist layer CF and the active components are sequentially integrated, which is called the color filter on array (COA). In the present embodiment, the color resist layer CF includes a first color resist CF1, a second color resist CF2, and a third color resist CF3. The optical properties of the first color resist CF1, the second color resist CF2, and the third color resist CF3 could be different from each other. For example, the first color resist CF1, the second color resist CF2, and the third color resist CF3 could each be a red color resist pattern, a green color resist pattern, and a blue color resist pattern, but the disclosure is not limited thereto. In some embodiments, the adjacent color resists among the first color resist CF1, the second color resist CF2, and the third color resist CF3 could overlap on the data line pattern DL. For example, the first color resist CF1 and the second color resist CF2 could overlap on the data line pattern DL. Based on the above, the overlapping portion of the first color resist CF1 and the second color resist CF2 could have the effect(s) of light-shielding and/or anti-reflective. Similarly, the overlapping portion of the second color resist CF2 and the third color resist CF3 and the overlapping portion of the third color resist CF3 and the first color resist CF1 could also have the effect(s) of light-shielding and/or anti-reflective.

In some embodiments, the display device 10a further includes a planarization layer PL. The planarization layer PL is disposed on the thin-film transistor substrate SB1 and is located between the color resist layer CF and the light-shielding layer 100. A material of the planarization layer PL could be organic insulating material, but the disclosure is not limited thereto. In the present embodiment, the planarization layer PL has a relatively flat top surface, so that the light-shielding layer 100 formed thereon could have a relatively good yield.

In some embodiments, the display device 10a further includes a backlight module (not shown). For example, the backlight module is disposed on a surface of the thin-film transistor substrate SB1 away from the counter substrate SB2, but the disclosure is not limited thereto. The backlight module could also be disposed on a side surface of the thin-film transistor substrate SB1. In some embodiments, the backlight module includes a reflective sheet (not shown), a light guide plate (not shown), a lower diffusion sheet (not shown), and an upper diffusion sheet (not shown), wherein the reflective sheet, the light guide plate, the lower diffusion sheet and the upper diffusion sheet could be stacked in this order, but the disclosure is not limited thereto. The reflective sheet has high reflectance, and could be used to reflect the light passing through the light guide plate back into the light guide plate, thereby increasing the efficient use of light in the display device 10a. The light guide plate has high transmittance, and could be used to guide the direction in which light travels. In detail, the light guide plate could provide light emitted by a direct light source (not shown) or a side-entry light source (not shown) into the display device 10a. The lower diffusion sheet is used to diffuse the light from the light guide plate, and has high transmittance, and the upper diffusion sheet is used to further diffuse the light from the light guide plate, and could be used to cover the blemishes.

In the present embodiment, the light-shielding layer 100 and the color resist layer CF are integrated on the thin-film transistor substrate SB1, so that the light-shielding layer 100 disposed on the color resist layer CF could reduce the phenomenon of mixed light from the backlight module, thereby improving the contrast ratio of the display device 10a when viewing at a wide viewing angle.

It is worth noting that although the light-shielding layer 100 and the color resist layer CF integrated on the thin-film transistor substrate SB1 are shown in the present embodiment, the disclosure is not limited thereto. In other embodiments, the light-shielding layer 100 and the color resist layer CF could be integrated on the counter substrate SB2.

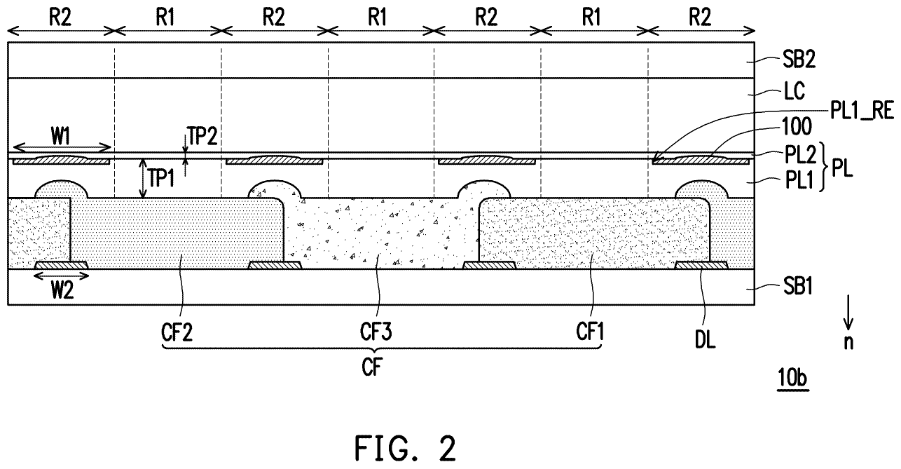

FIG. 2 is a schematic cross-sectional view of a display device according to a second embodiment of the present disclosure. It should be noted that the embodiment of FIG. 2 could use the reference numbers and portions of the content of the above embodiment of FIG. 1, wherein the same or similar reference numbers are used to represent the same or similar elements, and descriptions of the same technical contents are omitted.

Referring to FIG. 2, the main difference between a display device 10b of the present embodiment and the display device 10a is that the planarization layer PL includes a first planarization layer PL1 and a second planarization layer PL2, and the light-shielding layer 100 is disposed between the first planarization layer PL1 and the second planarization layer PL2.

In detail, in the present embodiment, the planarization layer PL includes the first planarization layer PL1 and the second planarization layer PL2 stacked in this other in the top-view direction n of the display device 10b. The first planarization layer PL1 has a recess PL1_RE, wherein the recess PL1_RE could be formed by performing a patterning process using a binary mask or a half-tone mask. The light-shielding layer 100 is disposed in the recess PL1_RE of the first planarization layer PL1, and the second planarization layer PL2 covers the light-shielding layer 100.

In the present embodiment, the second planarization layer PL2 is disposed on the first planarization layer PL1 and a thickness TP1 of the first planarization layer PL1 is greater than a thickness TP2 of the second planarization layer PL2, but the disclosure is not limited thereto.

In other embodiments, the first planarization layer PL could not have the recess PL1_RE, and the light-shielding layer 100 is disposed on a surface of the first planarization layer PL1, but the disclosure is not limited thereto.

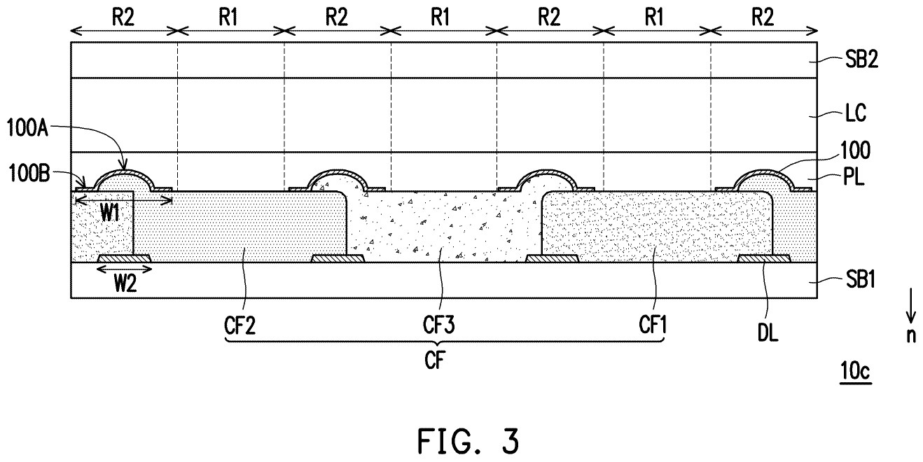

FIG. 3 is a schematic cross-sectional view of a display device according to a third embodiment of the present disclosure. It should be noted that the embodiment of FIG. 3 could use the reference numbers and portions of the content of the above embodiment of FIG. 1, wherein the same or similar reference numbers are used to represent the same or similar elements, and descriptions of the same technical contents are omitted.

Referring to FIG. 3, the main difference between a display device 10c of the present embodiment and the display device 10a is that the light-shielding layer 100 is disposed between the planarization layer PL and the color resist layer CF.

In the present embodiment, a formation process of the light-shielding layer 100 could be performed before a formation process of the planarization layer PL. Therefore, the light-shielding layer 100 could be disposed between the planarization layer PL and the color resist layer CF. In the present embodiment, the light-shielding layer 100 is disposed on the overlapping portion of the adjacent color resists, so that the light-shielding layer 100 has an arc shape in the cross-sectional view of the display device 10c. In detail, the light-shielding layer 100 of the present embodiment has a first portion 100A and a second portion 100B, wherein the overlapping portion of the first portion 100A and the two adjacent color resists overlap in the top-view direction n of the display device 10c, and the overlapping portion of the second portion 100B and the two adjacent color resists do not overlap in the top-view direction n of the display device 10c. Based on the above, the first portion 100A of the light-shielding layer 100 has a curved surface in the cross-sectional view of the display device 10c, and the second portion 100B of the light-shielding layer 100 has a flat surface in the cross-sectional view of the display device 10c.

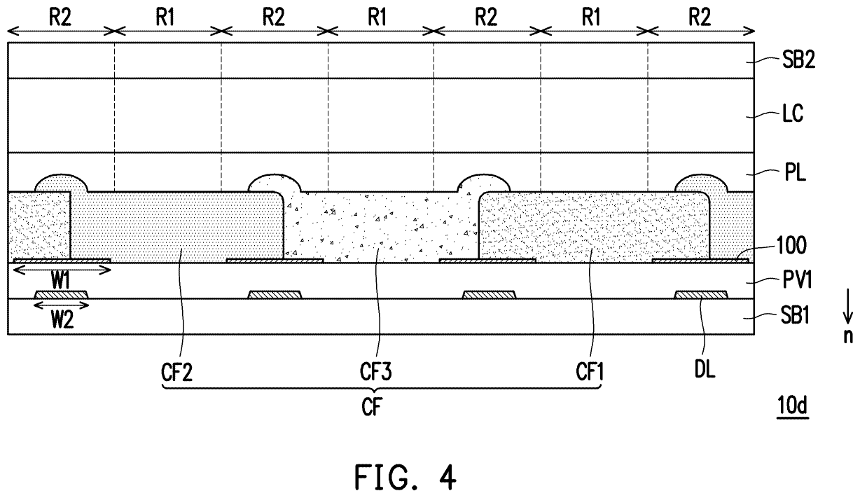

FIG. 4 is a schematic cross-sectional view of a display device according to a fourth embodiment of the present disclosure. It should be noted that the embodiment of FIG. 4 could use the reference numbers and portions of the content of the above embodiment of FIG. 1, wherein the same or similar reference numbers are used to represent the same or similar elements, and descriptions of the same technical contents are omitted.

Referring to FIG. 4, the main difference between a display device 10d of the present embodiment and the display device 10a is that the light-shielding layer 100 is disposed between the data line pattern DL and the color resist layer CF.

In the present embodiment, a formation process of the light-shielding layer 100 could be performed before a formation process of the color resist layer CF. Therefore, the light-shielding layer 100 could be disposed between the data line pattern DL and the color resist layer CF. From another perspective, the color resist layer CF could be disposed between the planarization layer PL and the light-shielding layer 100.

In the present embodiment, the display device 10d further includes an insulating layer PV1, wherein the insulating layer PV1 is disposed between the light-shielding layer 100 and the data line pattern DL to electrically isolate the light-shielding layer 100 from the data line pattern DL. A material of the insulating layer PV1 could include inorganic material (such as silicon oxide, silicon nitride, silicon oxynitride, or a combination thereof), organic material (such as polyimide resin, epoxy resin or acrylic resin), or a combination thereof, but the disclosure is not limited thereto.

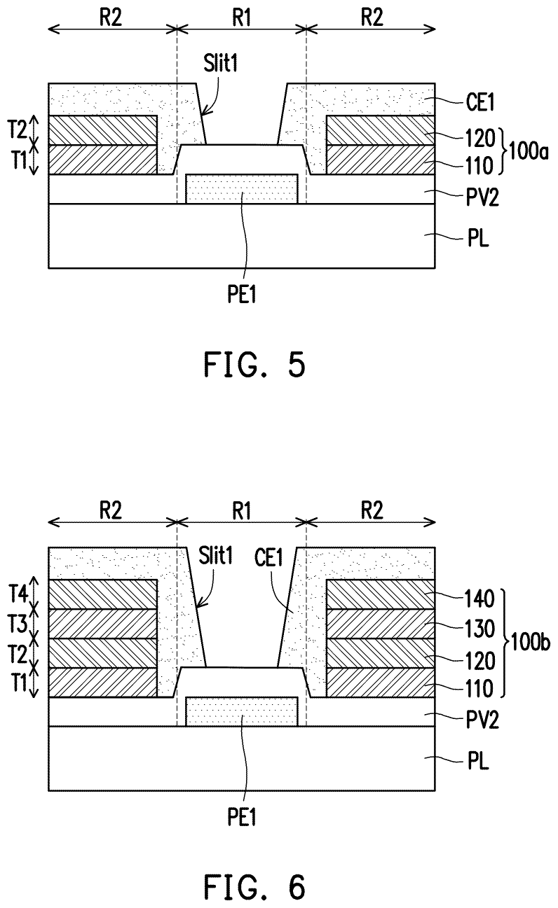

FIG. 5 is a partial cross-sectional view of a region provided with a light-shielding layer in the display device according to the first embodiment of the present disclosure. It should be noted that the embodiment of FIG. 5 could use the reference numbers and portions of the content of the above embodiment of FIG. 1, wherein the same or similar reference numbers are used to represent the same or similar elements, and descriptions of the same technical contents are omitted.

Referring to FIG. 5, a region r of the display device 10a shown in FIG. 1 is taken as an example in the following embodiment, but the disclosure is not limited thereto. Namely, the region r shown in FIG. 5 could be applied to the display device 10b, the display device 10c, or the display device 10d. In the present embodiment, the display device 10a further includes a pixel electrode PE1, an insulating layer PV2 and a common electrode CE1.

The pixel electrode PE1 is disposed on the planarization layer PL. In some embodiments, a material of the pixel electrode PE1 could include metal oxide conductive materials (such as indium tin oxide, indium zinc oxide, aluminum tin oxide, aluminum zinc oxide, and/or indium germanium zinc oxide), but the disclosure is not limited thereto. The pixel electrode PE1 is disposed in the opening area R1 of the display device 10a; that is, the pixel electrode PE1 is disposed in an area through which light could pass.

The insulating layer PV2 is disposed on the pixel electrode PE1. In some embodiments, the insulating layer PV2 covers the pixel electrode PE1, but the disclosure is not limited thereto. A material of the insulating layer PV2 could be the same as or similar to the material of the insulating layer PV1, which would be omitted herein.

The common electrode CE1 is disposed on the insulating layer PV2. In some embodiments, a material of the common electrode CE1 could include metal oxide conductive materials (such as indium tin oxide, indium zinc oxide, aluminum tin oxide, aluminum zinc oxide, and/or indium germanium zinc oxide), but the disclosure is not limited thereto. In the present embodiment, the common electrode CE1 includes a slit Slit1 located in the opening area R1, but the disclosure is not limited thereto.

In the present embodiment, the light-shielding layer 100a is disposed between the insulating layer PV2 and the common electrode CE1, and includes a two-layer structure. In detail, the light-shielding layer 100a includes a first metal layer 110 and a second metal layer 120 stacked in this order in the top-view direction n of the display device 10a; that is, the first metal layer 110 is disposed on the insulating layer PV2, and the second metal layer 120 is disposed on the first metal layer 110. A material of the first metal layer 110 includes metal (such as molybdenum (Mo), aluminum (Al), titanium (Ti), titanium nitride (TiN), tungsten (W), silver (Ag) or a combination thereof), and a material of the second metal layer 120 includes metal oxide. In the present embodiment, the material of the first metal layer 110 is molybdenum (Mo), tungsten (W) or a combination thereof, and the material of the second metal layer 120 is molybdenum tantalum oxide (MoOₓTa), but the disclosure is not limited thereto. In other embodiments, a color of the material of the second metal layer 120 could be black or approximately black, but the disclosure is not limited thereto. Based on the above, the light-shielding layer 100a could be used to define the non-opening area R2 of the display device 10a.

A thickness T1 of the first metal layer 110 and a thickness T2 of the second metal layer 120 are 10 nm to 100 nm. In the present embodiment, the thickness T2 of the second metal layer 120 is greater than the thickness T1 of the first metal layer 110. In some embodiments, a ratio of the thickness T1 of the first metal layer 110 to the thickness T2 of the second metal layer 120 is greater than or equal to 0.1 and less than 1. For example, the thickness T1 of the first metal layer 110 is 50 nm, and the thickness T2 of the second metal layer 120 is 60 nm, but the disclosure is not limited thereto. In the present embodiment, a refractive index of the first metal layer 110 is greater than a refractive index of the second metal layer 120. For example, when the material of the first metal layer 110 is Mo and has the thickness of 50 nm, the refractive index of the first metal layer 110 is 3.16629; and when the material of the second metal layer 120 is MoOₓTa and has the thickness of 60 nm, the refractive index of the second metal layer 120 is 2.34954. In the present embodiment, an extinction coefficient of the first metal layer 110 is greater than an extinction coefficient of the second metal layer 120. For example, when the material of the first metal layer 110 is Mo and has the thickness of 50 nm, the extinction coefficient of the first metal layer 110 is 2.23463 when illuminated by light with a wavelength of 550 nm. When the material of the second metal layer 120 is MoOₓTa and has the thickness of 60 nm, the extinction coefficient of the second metal layer 120 is 0.49925 when illuminated by light with a wavelength of 550 nm.

In other embodiments, the thickness T2 of the second metal layer 120 is smaller than the thickness T1 of the first metal layer 110. In some embodiments, a ratio of the thickness T1 of the first metal layer 110 to the thickness T2 of the second metal layer 120 is greater than 1 and less than or equal to 10. For example, the ratio of the thickness T1 of the first metal layer 110 to the thickness T2 of the second metal layer 120 could be 2, 3, 4, 5, 6, 7, 8, or 9, but the disclosure is not limited thereto.

Therefore, the light-shielding layer 100a could have the characteristics of low transmittance and/or low reflectance by making the stack and/or parameters of the light-shielding layer 100a comply with the above relationships, which could reduce light from the backlight module penetrating the light-shielding layer 100a and/or reduce the reflection of light from the environment by the light-shielding layer 100a, so that the display quality of the display device 10a could be improved.

FIG. 6 is a partial cross-sectional view of a region provided with a light-shielding layer in the display device according to the second embodiment of the present disclosure. It should be noted that the embodiment of FIG. 6 could use the reference numbers and portions of the content of the above embodiment of FIG. 5, wherein the same or similar reference numbers are used to represent the same or similar elements, and descriptions of the same technical contents are omitted.

Referring to FIG. 6, the main difference between the light-shielding layer 100b of the present embodiment and the light-shielding layer 100a is that the light-shielding layer 100b further includes a third metal layer 130 and a fourth metal layer 140.

In the present embodiment, the light-shielding layer 100b includes a four-layer structure. In detail, the light-shielding layer 100b includes the first metal layer 110, the second metal layer 120, the third metal layer 130 and the fourth metal layer 140 stacked in this order in the top-view direction n of the display device 10a; that is, the first metal layer 110 is disposed on the insulating layer PV2, the second metal layer 120 is disposed on the first metal layer 110, the third metal layer 130 is disposed on the second metal layer 120, and the fourth metal layer 140 is disposed on the third metal layer 130. A material of the third metal layer 130 includes metal (such as molybdenum (Mo), aluminum (Al), titanium (Ti), titanium nitride (TiN), tungsten (W), silver (Ag) or a combination thereof), and a material of the fourth metal layer 140 includes metal oxide. In the present embodiment, the material of the third metal layer 130 is molybdenum (Mo), tungsten (W) or a combination thereof, and the material of the fourth metal layer 140 is molybdenum tantalum oxide (MoOₓTa), but the disclosure is not limited thereto. In other embodiments, a color of the material of the second metal layer 120 could be black or approximately black, but the disclosure is not limited thereto.

A thickness T3 of the third metal layer 130 and a thickness T4 of the fourth metal layer 140 are 10 nm to 100 nm. In the present embodiment, the thickness T4 of the fourth metal layer 140 is greater than the thickness T3 of the third metal layer 130. In some embodiments, a ratio of the thickness T3 of the third metal layer 130 to the thickness T4 of the fourth metal layer 140 is greater than or equal to 0.1 and less than 1. For example, the thickness T3 of the third metal layer 130 is 50 nm, and the thickness T4 of the fourth metal layer 140 is 60 nm, but the disclosure is not limited thereto.

In the present embodiment, a refractive index of the third metal layer 130 is greater than a refractive index of the fourth metal layer 140. For example, when the material of the third metal layer 130 is Mo and has the thickness of 50 nm, the refractive index of the third metal layer 130 is 3.16629; and when the material of the fourth metal layer 140 is MoOₓTa and has the thickness of 60 nm, the refractive index of the fourth metal layer 140 is 2.34954.

In the present embodiment, the thickness T4 of the fourth metal layer 140 is greater than the thickness T2 of the second metal layer 120. In some embodiments, a ratio of the thickness T4 of the fourth metal layer 140 to the thickness T2 of the second metal layer 120 is greater than 0.5 and less than or equal to 1.7.

Therefore, the light-shielding layer 100b could have the characteristics of low transmittance and/or low reflectance by making the stack and/or parameters of the light-shielding layer 100b comply with the above relationships, which could reduce light from the backlight module penetrating the light-shielding layer 100b and/or reduce the reflection of light from the environment by the light-shielding layer 100b, so that the display quality of the display device 10a could be improved.

It is worth noting that the light-shielding layer 100b could not include the fourth metal layer 140 in other embodiments; that is, the light-shielding layer 100b could include a three-layer structure.

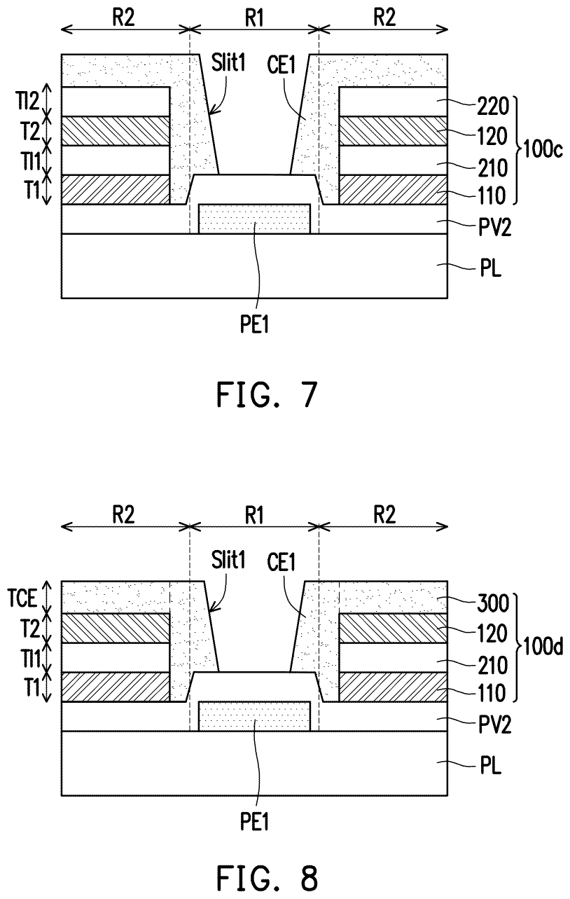

FIG. 7 is a partial cross-sectional view of a region provided with a light-shielding layer in the display device according to the third embodiment of the present disclosure. It should be noted that the embodiment of FIG. 7 could use the reference numbers and portions of the content of the above embodiment of FIG. 5, wherein the same or similar reference numbers are used to represent the same or similar elements, and descriptions of the same technical contents are omitted.

Referring to FIG. 7, the main difference between the light-shielding layer 100c of the present embodiment and the light-shielding layer 100a is that the light-shielding layer 100c further includes a first insulating layer 210 and a second insulating layer 220.

In the present embodiment, the light-shielding layer 100c includes a four-layer structure. In detail, the light-shielding layer 100c includes the first metal layer 110, the first insulating layer 210, the second metal layer 120 and the second insulating layer 220 stacked in this order in the top-view direction n of the display device 10a; that is, the first metal layer 110 is disposed on the insulating layer PV2, the second metal layer 120 is disposed on the first metal layer 110, the first insulating layer 210 is disposed between the first metal layer 110 and the second metal layer 120, and the second insulating layer 220 is disposed on the second metal layer 120. A material of the first metal layer 110 and a material of the second metal layer 120 include Mo, W or a combination thereof, and a material of the first insulating layer 210 and a material of the second insulating layer 220 include inorganic material, which could be silicon oxide, silicon nitride, or silicon oxynitride. In addition, the material of the first insulating layer 210 and the material of the second insulating layer 220 could be the same as or different from each other. In some embodiments, the material of the first insulating layer 210 and the material of the second insulating layer 220 are the same, and the material of the first insulating layer 210 and the material of the second insulating layer 220 are both silicon nitride, but the disclosure is not limited thereto. In other embodiments, the material of the first insulating layer 210 and the material of the second insulating layer 220 are different, wherein the material of the first insulating layer 210 is silicon nitride, and the material of the second insulating layer 220 is silicon oxide.

A thickness TI1 of the first insulating layer 210 and a thickness TI2 of the second insulating layer 220 are 10 nm to 100 nm. The thickness TI1 of the first insulating layer 210 could be greater than, equal to, or less than the thickness TI2 of the second insulating layer 220. For example, the thickness TI1 of the first insulating layer 210 is 50 nm, and the thickness TI2 of the second insulating layer 220 is 50 nm, but the disclosure is not limited thereto. In the present embodiment, when the material of the first insulating layer 210 and the material of the second insulating layer 220 are both silicon nitride, a ratio of the thickness TI2 of the second insulating layer 220 and the thickness TI1 of the first insulating layer 210 is greater than or equal to 0.2 and less than or equal to 1.7; and when the material of the first insulating layer 210 is silicon nitride and the material of the second insulating layer 220 is silicon oxide, a ratio of the thickness TI2 of the second insulating layer 220 and the thickness TI1 of the first insulating layer 210 is greater than 0 and less than or equal to 1.5. In the present embodiment, when the material of the first insulating layer 210 is silicon nitride and the material of the second insulating layer 220 is silicon oxide, a refractive index of the second insulating layer 220 is smaller than a refractive index of the first insulating layer 210. In detail, the refractive index of the second insulating layer 220 is 1.498, and the refractive index of the first insulating layer 210 is 1.89131.

Therefore, the light-shielding layer 100c could have the characteristics of low transmittance and/or low reflectance by making the stack and/or parameters of the light-shielding layer 100c comply with the above relationships, which could reduce light from the backlight module penetrating the light-shielding layer 100c and/or reduce the reflection of light from the environment by the light-shielding layer 100c, so that the display quality of the display device 10a could be improved.

It is worth noting that the light-shielding layer 100c could not include the second insulating layer 220 in other embodiments; that is, the light-shielding layer 100c could include a three-layer structure.

FIG. 8 is a partial cross-sectional view of a region provided with a light-shielding layer in the display device according to the fourth embodiment of the present disclosure. It should be noted that the embodiment of FIG. 8 could use the reference numbers and portions of the content of the above embodiment of FIG. 7, wherein the same or similar reference numbers are used to represent the same or similar elements, and descriptions of the same technical contents are omitted.

Referring to FIG. 8, the main difference between the light-shielding layer 100d of the present embodiment and the light-shielding layer 100c is that the light-shielding layer 100d does not include the second insulating layer 220.

It is worth noting that a portion 300 that the common electrode CE1 (its refractive index is 1.77384) and the second metal layer 120 are stacked could be used as a part of the light-shielding layer 100d in the present embodiment. Therefore, the light-shielding layer 100d could also be regarded as including a four-layer structure.

A thickness TCE of the portion 300 that the common electrode CE1 and the second metal layer 120 are stacked are 10 nm to 100 nm. For example, the thickness TCE is 42 nm, but the disclosure is not limited thereto.

Therefore, the light-shielding layer 100d could have the characteristics of low transmittance and/or low reflectance by making the stack and/or parameters of the light-shielding layer 100d comply with the above relationships, which could reduce light from the backlight module penetrating the light-shielding layer 100d and/or reduce the reflection of light from the environment by the light-shielding layer 100d, so that the display quality of the display device 10a could be improved.

FIG. 9 is a partial cross-sectional view of a region provided with a light-shielding layer in the display device according to a fifth embodiment of the present disclosure. It should be noted that the embodiment of FIG. 9 could use the reference numbers and portions of the content of the above embodiment of FIG. 5, wherein the same or similar reference numbers are used to represent the same or similar elements, and descriptions of the same technical contents are omitted.

Referring to FIG. 9, the main difference is that the light-shielding layer 100a is disposed on the common electrode CE1. Namely, in the present embodiment, the common electrode CE1 is disposed between the light-shielding layer 100a and the insulating layer PV2.

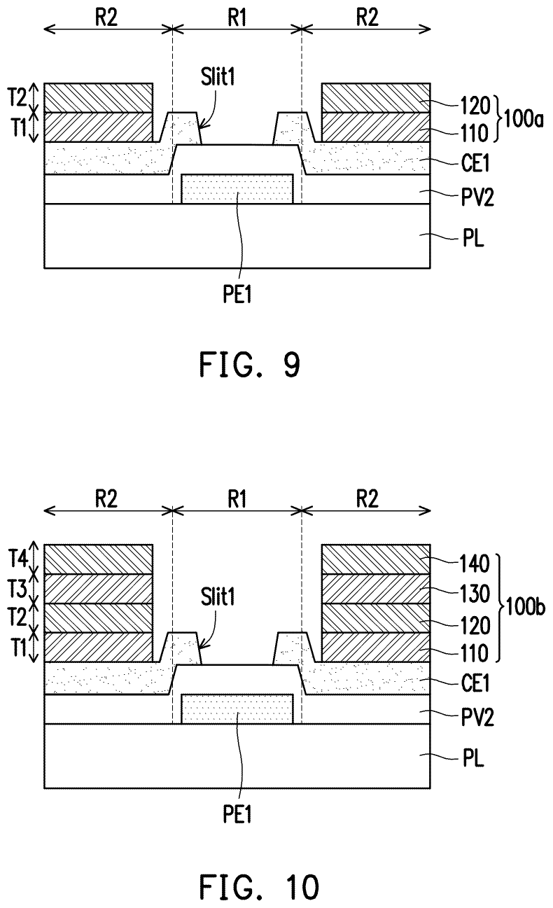

FIG. 10 is a partial cross-sectional view of a region provided with a light-shielding layer in the display device according to a sixth embodiment of the present disclosure. It should be noted that the embodiment of FIG. 10 could use the reference numbers and portions of the content of the above embodiment of FIG. 6, wherein the same or similar reference numbers are used to represent the same or similar elements, and descriptions of the same technical contents are omitted.

Referring to FIG. 10, the main difference is that the light-shielding layer 100b is disposed on the common electrode CE1. Namely, in the present embodiment, the common electrode CE1 is disposed between the light-shielding layer 100b and the insulating layer PV2.

FIG. 11 is a partial cross-sectional view of a region provided with a light-shielding layer in the display device according to a seventh embodiment of the present disclosure. It should be noted that the embodiment of FIG. 11 could use the reference numbers and portions of the content of the above embodiment of FIG. 7, wherein the same or similar reference numbers are used to represent the same or similar elements, and descriptions of the same technical contents are omitted.

Referring to FIG. 11, the main difference is that the light-shielding layer 100c is disposed on the common electrode CE1. Namely, in the present embodiment, the common electrode CE1 is disposed between the light-shielding layer 100c and the insulating layer PV2.

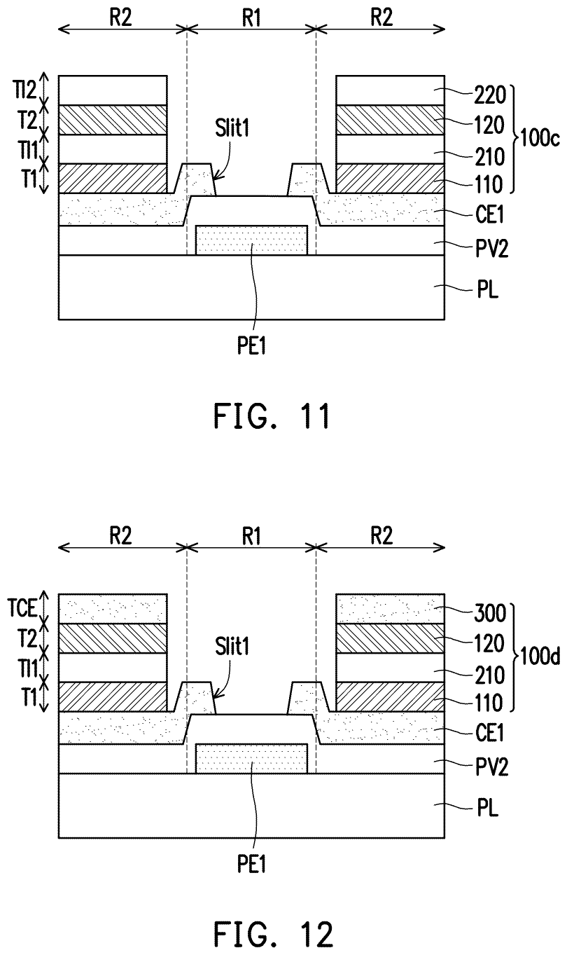

FIG. 12 is a partial cross-sectional view of a region provided with a light-shielding layer in the display device according to an eighth embodiment of the present disclosure. It should be noted that the embodiment of FIG. 12 could use the reference numbers and portions of the content of the above embodiment of FIG. 8, wherein the same or similar reference numbers are used to represent the same or similar elements, and descriptions of the same technical contents are omitted.

Referring to FIG. 12, the main difference is that a light-shielding layer 100d′ is disposed on the common electrode CE1. Namely, in the present embodiment, the common electrode CE1 is disposed between the light-shielding layer 100d′ and the insulating layer PV2, and the light-shielding layer 100d′ includes a first conductive layer 300.

In detail, the light-shielding layer 100d′ includes the first metal layer 110, the first insulating layer 210, the second metal layer 120 and the first conductive layer 300 stacked in this order in the top-view direction n of the display device 10a. A material of the first conductive layer 300 could be the same as or similar to the material of the common electrode CE1, which would be omitted herein.

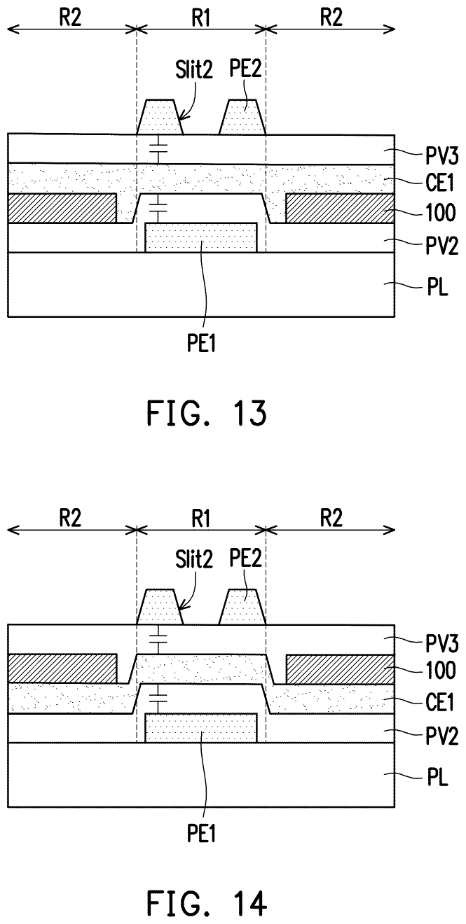

FIG. 13 is a partial cross-sectional view of a region provided with a light-shielding layer in the display device according to a ninth embodiment of the present disclosure. It should be noted that the embodiment of FIG. 13 could use the reference numbers and portions of the content of the above embodiments of FIGS. 1 and 5, wherein the same or similar reference numbers are used to represent the same or similar elements, and descriptions of the same technical contents are omitted.

Referring to FIG. 13, the main difference is the display device 10a further includes an insulating layer PV3 and a pixel electrode PE2.

The insulating layer PV3 is disposed on the common electrode CE1. In some embodiments, the insulating layer PV3 covers the common electrode CE1, but the disclosure is not limited thereto. A material of the insulating layer PV3 could be the same as or similar to the material of the insulating layer PV1, which would be omitted herein.

The pixel electrode PE2 is disposed on the insulating layer PV3. A material of the pixel electrode PE2 could be the same as or similar to the material of the pixel electrode PE1, which would be omitted herein. In the present embodiment, the pixel electrode PE2 includes a slit Slit2 located in the opening area R1, but the disclosure is not limited thereto.

It is worth noting that the light-shielding layer 100 of the present embodiment could be any of the light-shielding layer 100a, the light-shielding layer 100b, the light-shielding layer 100c and the light-shielding layer 100d stated in the above embodiments.

FIG. 14 is a partial cross-sectional view of a region provided with a light-shielding layer in the display device according to a tenth embodiment of the present disclosure. It should be noted that the embodiment of FIG. 14 could use the reference numbers and portions of the content of the above embodiment of FIG. 13, wherein the same or similar reference numbers are used to represent the same or similar elements, and descriptions of the same technical contents are omitted.

Referring to FIG. 14, the main difference is that the light-shielding layer 100 is disposed between the common electrode CE1 and the insulating layer PV3. Namely, in the present embodiment, the common electrode CE1 is disposed between the light-shielding layer 100 and the insulating layer PV2.

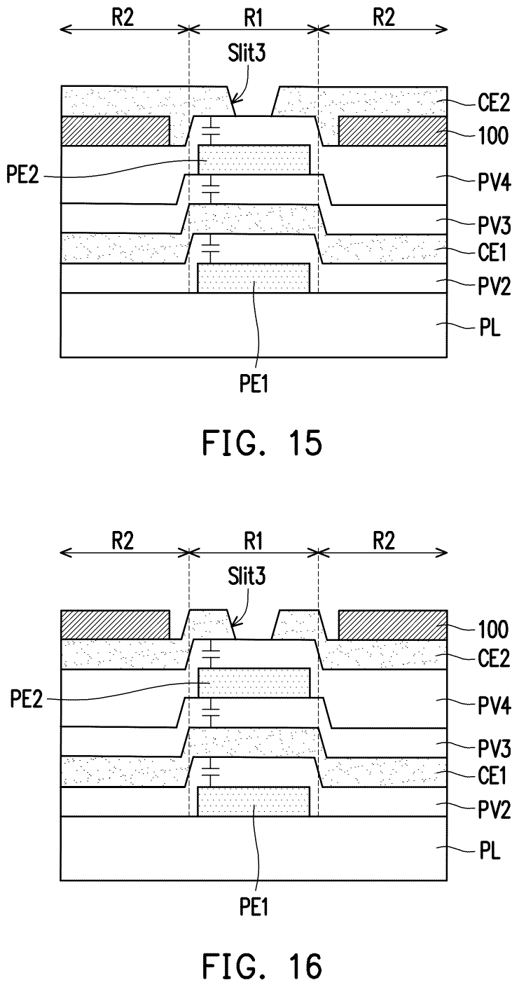

FIG. 15 is a partial cross-sectional view of a region provided with a light-shielding layer in the display device according to an eleventh embodiment of the present disclosure. It should be noted that the embodiment of FIG. 15 could use the reference numbers and portions of the content of the above embodiment of FIG. 13, wherein the same or similar reference numbers are used to represent the same or similar elements, and descriptions of the same technical contents are omitted.

Referring to FIG. 15, the main difference is the display device 10a further includes an insulating layer PV4 and a common electrode CE2.

The insulating layer PV4 is disposed on the pixel electrode PE2. In some embodiments, the insulating layer PV4 covers the pixel electrode PE2, but the disclosure is not limited thereto. A material of the insulating layer PV4 could be the same as or similar to the material of the insulating layer PV1, which would be omitted herein.

The common electrode CE2 is disposed on the insulating layer PV4. A material of the common electrode CE2 could be the same as or similar to the material of the common electrode CE1, which would be omitted herein. In the present embodiment, the common electrode CE2 includes a slit Slit3 located in the opening area R1, but the disclosure is not limited thereto.

In addition, in the present embodiment, the light-shielding layer 100 is disposed between the common electrode CE2 and the insulating layer PV4.

FIG. 16 is a partial cross-sectional view of a region provided with a light-shielding layer in the display device according to a twelfth embodiment of the present disclosure. It should be noted that the embodiment of FIG. 16 could use the reference numbers and portions of the content of the above embodiment of FIG. 15, wherein the same or similar reference numbers are used to represent the same or similar elements, and descriptions of the same technical contents are omitted.

Referring to FIG. 16, the main difference is that the light-shielding layer 100 is disposed on the common electrode CE2. Namely, in the present embodiment, the common electrode CE2 is disposed between the light-shielding layer 100 and the insulating layer PV4.

In summary, the light-shielding layer in the display device provided by an embodiment of the present disclosure could have the characteristics of low transmittance and/or low reflectance by making the stack and/or parameters of the light-shielding layer comply with the above relationships, which could reduce light from the backlight module penetrating the light-shielding layer and/or reduce the reflection of light from the environment by the light-shielding layer, so that the display quality of the display device provided by the embodiment of the present disclosure could be improved.

In addition, the light-shielding layer and the color resist layer in the display device provided by another embodiment of the present disclosure are integrated on the same thin-film transistor substrate, so that the phenomenon of mixed color image when viewing the display device at the oblique viewing angle could be reduced, thereby improving the contrast ratio of the display device provided by another embodiment of the present disclosure when viewing at a wide viewing angle.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A display device, including:
a thin-film transistor substrate;
a counter substrate, correspondingly disposed on the thin-film transistor substrate;
a display medium, sandwiched between the thin-film transistor substrate and the counter substrate;
a data line pattern, disposed on the thin-film transistor substrate;
a light-shielding layer, disposed on the data line pattern and includes a first metal layer and a second metal layer; and
a color resist layer, disposed between the data line pattern and the light-shielding layer,
wherein the second metal layer is disposed on the first metal layer, and a thickness of the second metal layer is greater than a thickness of the first metal layer.

2. The display device according to claim 1, wherein the color resist layer includes a first color resist and a second color resist, and the first color resist and the second color resist overlap on the data line pattern.

3. The display device according to claim 1, wherein in a cross-sectional view of the display device, a width of the light-shielding layer is greater than a width of the data line pattern.

4. The display device according to claim 1, wherein a ratio of the thickness of the first metal layer to the thickness of the second metal layer is greater than or equal to 0.1 and less than 1.

5. The display device according to claim 1, further including a planarization layer, wherein the planarization layer is disposed between the color resist layer and the light-shielding layer.

6. The display device according to claim 1, further including a planarization layer, wherein the planarization layer includes a first planarization layer and a second planarization layer, and the light-shielding layer is disposed between the first planarization layer and the second planarization layer.

7. The display device according to claim 6, wherein the second planarization layer is disposed on the first planarization layer, and a thickness of the first planarization layer is greater than a thickness of the second planarization layer.

8. The display device according to claim 1, further including a planarization layer, wherein the light-shielding layer is disposed between the planarization layer and the color resist layer.

9. The display device according to claim 8, wherein the light-shielding layer has a first portion and a second portion, the first portion has a curved surface, and the second portion has a flat surface.

10. The display device according to claim 1, wherein a material of the first metal layer is Mo, W or a combination thereof, and a material of the second metal layer is metal oxide.

11. The display device according to claim 1, wherein a refractive index of the first metal layer is greater than a refractive index of the second metal layer.

12. The display device according to claim 1, wherein an extinction coefficient of the first metal layer is greater than an extinction coefficient of the second metal layer.

13. The display device according to claim 1, wherein the light-shielding layer further includes a third metal layer and a fourth metal layer, and the fourth metal layer is disposed on the third metal layer.

14. The display device according to claim 13, wherein a material of the third metal layer is Mo, W or a combination thereof, and a material of the fourth metal layer is metal oxide.

15. The display device according to claim 13, wherein a refractive index of the third metal layer is greater than a refractive index of the fourth metal layer.

16. The display device according to claim 13, wherein a ratio of a thickness of the fourth metal layer to the thickness of the second metal layer is greater than 1 and less than or equal to 6.

17. The display device according to claim 1, wherein a material of the first metal layer and a material of the second metal layer are Mo, W or a combination thereof.

18. The display device according to claim 17, wherein the light-shielding layer further includes a first insulating layer and a second insulating layer, the first insulating layer is disposed between the first metal layer and the second metal layer, and the second insulating layer is disposed on the second metal layer.

19. A display device, including:
a thin-film transistor substrate;
a counter substrate, correspondingly disposed on the thin-film transistor substrate;
a display medium, sandwiched between the thin-film transistor substrate and the counter substrate;
a data line pattern, disposed on the thin-film transistor substrate;
a light-shielding layer, disposed on the data line pattern and includes a first metal layer and a second metal layer; and
a color resist layer, disposed on the light-shielding layer, wherein the light-shielding layer is disposed between the data line pattern and the color resist layer,
wherein the second metal layer is disposed on the first metal layer, and a thickness of the second metal layer is greater than a thickness of the first metal layer.

20. The display device according to claim 19, further including a planarization layer, wherein the color resist layer is disposed between the planarization layer and the light-shielding layer.
